(19) United States
(12) Patent Application Publication
(10) Pub. No.: US 2025/0290613 A1
(43) Pub. Date: Sep. 18, 2025

(54) LENS ASSEMBLY, VEHICLE LAMP AND VEHICLE

(71) Applicant: BEIJING CHEHEJIA AUTOMOBILE TECHNOLOGY CO., LTD., Beijing (CN)

(72) Inventors: Bolin SUN, Beijing (CN); Binbin TANG, Beijing (CN); Shiying ZHANG, Beijing (CN)

(21) Appl. No.: 18/861,036

(22) PCT Filed: Apr. 26, 2023
(86) PCT No.: PCT/CN2023/090954

§ 371 Date: Oct. 28, 2024

(30) Foreign Application Priority Data
Apr. 29, 2022 (CN) 202221043108.5

(51) Int. Cl. F21S 41/43; F21S 41/27

(52) U.S. Cl. CPC F21S 41/43; F21S 41/27

(57) ABSTRACT

A lens assembly, a vehicle lamp and a vehicle. The lens assembly comprises a lens and a light blocking member. The lens has a plurality of light incident surfaces; and the light blocking member comprises a light blocking portion, wherein the light blocking portion is arranged between two adjacent light incident surfaces so as to separate the two adjacent light incident surfaces from each other.

### CROSS-REFERENCE TO RELATED APPLICATION

The present disclosure claims the priority of Chinese patent application filed on Apr. 29, 2022 with the application number of 2022210431085 before China National Intellectual Property Administration, which is incorporated herein in its entirety by reference.

### TECHNICAL FIELD

The present disclosure relates to the technical field of automotive accessories and more particularly, to a lens assembly, a vehicle lamp and a vehicle.

### BACKGROUND

Vehicle lamps include a light source, a reflector and a lens. The light source includes a plurality of light sources, the reflector has a plurality of light reflection surfaces, and the lens has a plurality of light incident surfaces. The light source, the light reflection surface and the corresponding light incident surface form an optical unit; and the plurality of light sources, the plurality of light reflection surfaces and the plurality of light incident surfaces form a plurality of optical units. In each of the plurality of optical units, light emitted by the light source is reflected by the corresponding light reflection surface and then converged near a focus of the corresponding light incident surface, and the light emitted by the plurality of light sources is finally refracted to a road surface by the lens to form illumination. In the related art, in order to improve brightness and light efficiency, reflectors with relatively small focal lengths are usually used, resulting in a part of the light emitted by the light source not passing through the focus of the light reflection surface, that is, defocus. For the convenience of description and understanding, the light emitted by the light source that does not pass through the focus of the light reflection surface is taken as defocus light. The defocus light cannot irradiate the corresponding light incident surface and is prone to irradiate light incident surfaces of adjacent optical units, which eventually causes the defocus light to form stray light on the road surface, thereby affecting the road lighting effect and the driving safety of a vehicle.

### SUMMARY

The present disclosure aims to solve one of the technical problems in the related art at least to some extent.

Therefore, an embodiment of the present disclosure provides a lens assembly to reduce or even avoid stray light generated by a vehicle lamp with the lens assembly.

An embodiment of the present disclosure provides a vehicle lamp to improve the road lighting effect of the vehicle lamp.

An embodiment of the present disclosure provides a vehicle to improve the safety of the vehicle.

The lens assembly of the embodiment of the present disclosure includes a lens and a light blocking member, the lens includes a plurality of light incident surfaces, and the light blocking member includes a plurality of light blocking portions, each of the plurality of light blocking portions is arranged between two adjacent light incident surfaces in the plurality of light incident surfaces to separate the two adjacent light incident surfaces.

In some embodiments, the lens includes a plurality of light-emitting surfaces corresponding to the plurality of light incident surfaces, each of the plurality of light incident surfaces is a light incident surface collimated in a first direction, each of the plurality of light-emitting surfaces is a light-emitting surface collimated in a second direction, each of a plurality of partitions is formed between two adjacent light incident surfaces, and each of the plurality of light blocking portions is arranged corresponding to one of the plurality of partitions, among them, the first direction is orthogonal to the second direction.

In some embodiments, the light blocking portion is a light blocking plate or a light blocking strip; and/or a spacing between each of the plurality of partitions and adjacent light incident surface is from 0.1 mm to 1 mm; and/or a size of each of the plurality of light blocking portions in the first direction is from 0.1 mm to 2 mm.

In some embodiments, the plurality of light incident surfaces are spaced apart from the plurality of light-emitting surfaces along a third direction, wherein the third direction is orthogonal to the second direction and the first direction.

In some embodiments, a size of each of the plurality of light blocking portions in the second direction is greater than or equal to a size of each of the plurality of light incident surfaces; and/or a size of each of the plurality of light blocking portions in the third direction is from 1 mm to 10 mm; and/or the light blocking member further includes a connecting portion, the plurality of light blocking portions are connected to the connecting portion, and the connecting portion is connected to the lens.

In some embodiments, the light blocking member includes a connecting portion, the connecting portion is a connecting plate, and the connecting portion includes a plurality of escape portions for the plurality of light incident surfaces to pass through, the plurality of escape portions correspond to the plurality of light incident surfaces in a one-to-one correspondence, each of the plurality of light incident surfaces is arranged in a corresponding escape portion, and each of the plurality of light blocking portions is arranged between two adjacent escape portions in the plurality of escape portions.

In some embodiments, the escape portion is an escape hole, a hole wall of the escape hole includes a first stopping portion and a second stopping portion oppositely arranged in the second direction, and the first stopping portion and the second stopping portion respectively stop at both ends of the lens in the second direction; or the escape portion is an escape groove, a groove wall of the escape groove includes a first stopping portion and a second stopping portion oppositely arranged in the second direction, and the first stopping portion and the second stopping portion respectively stop at both ends of the lens in the second direction.

In some embodiments, when the escape portion is the escape hole, the hole wall includes a first thickening portion and a second thickening portion, a thickness of the first thickening portion and the second thickening portion is greater than a thickness of a remaining portion of the hole wall, the first thickening portion forms the first stopping portion, and the second thickening portion forms the second stopping portion; or when the escape portion is the escape groove, the groove wall includes a first thickening portion and a second thickening portion, a thickness of the first thickening portion and the second thickening portion is greater than a thickness of a remaining portion of the groove wall, the first thickening portion forms the first stopping portion, and the second thickening portion forms the second stopping portion.

In some embodiments, the light blocking portion is a light blocking plate, and the light blocking portion is arranged on a side of the connecting portion away from the light-emitting surface.

In some embodiments, the light blocking member includes the connecting portion, and the lens assembly further includes a frame body, and both the connecting portion and the lens are connected to the frame body.

In some embodiments, the frame body is a cover body with an accommodating cavity, the lens is arranged in the accommodating cavity, and at least a part of the light blocking member is arranged in the accommodating cavity.

In some embodiments, the lens includes a lens body and a connecting arm which are connected, the plurality of light incident surfaces and the plurality of light-emitting surfaces are arranged on the lens body, and the connecting portion, the connecting arm and the frame body are detachably connected through fasteners; and/or one of the frame body and the connecting portion includes a positioning pillar, the other of the frame body and the connecting portion includes a first positioning hole, and the connecting arm includes a second positioning hole, wherein a part of the positioning pillar is inserted into the first positioning hole, the part of the positioning pillar is matched with the first positioning hole, another part of the positioning pillar is inserted into the second positioning hole, and the another part of the positioning pillar is matched with the second positioning hole.

In some embodiments, a cavity wall of the accommodating cavity includes a first stepped surface and a second stepped surface perpendicular to the third direction, the second stepped surface is located between the first stepped surface and the connecting portion in the third direction, the connecting arm stops at the first stepped surface in the third direction, and a part of the connecting portion stops at the second stepped surface in the third direction.

The vehicle lamp of the embodiment of the present disclosure includes the lens assembly described in any of the above embodiments.

In some embodiments, the vehicle lamp further includes a reflector, the reflector includes a plurality of light reflection surfaces, each of the plurality of light incident surfaces is arranged corresponding to one or more light reflection surfaces in the plurality of light reflection surfaces, and a focal length of the light reflection surfaces is from 0.5 mm to 3 mm.

The vehicle of the embodiment of the present disclosure includes the vehicle lamp described in any of the above embodiments.

According to the lens assembly of the embodiment of the present disclosure, by arranging the light blocking member and using the light blocking portion of the light blocking member to separate the two adjacent light incident surfaces, the light emitted by the light source can be effectively prevented from irradiating light incident surfaces of adjacent optical units to form the stray light, therefore, it is beneficial to improving the road lighting effect of the vehicle lamp with the lens assembly, and improve the driving safety of the vehicle with the vehicle lamp.

### BRIEF DESCRIPTION OF THE DRAWINGS

FIG. 1 is an exploded view of a lens assembly according to an embodiment of the present disclosure.

FIG. 2 is a schematic structural diagram of a lens assembly according to an embodiment of the present disclosure (with a frame body hidden).

FIG. 3 is a schematic structural diagram of a light blocking member in FIG. 1 from a first perspective.

FIG. 4 is a schematic structural diagram of a light blocking member in FIG. 1 from a second perspective.

FIG. 5 is a schematic structural diagram of a frame body in FIG. 1 from a first perspective.

FIG. 6 is a schematic structural diagram of a frame body in FIG. 1 from a second perspective.

FIG. 7 is an exploded view of a vehicle lamp according to an embodiment of the present disclosure.

FIG. 8 is a front view of a vehicle lamp according to an embodiment of the present disclosure (with a heat sink hidden).

FIG. 9 is a view taken along a line A-A of FIG. 8.

FIG. 10 is a schematic structural diagram of a lens, a reflector and a light source in FIG. 7.

FIG. 11 is a schematic diagram of directions of light rays during an operation of some optical units in FIG. 10.

FIG. 12 is an effect diagram of a light shape of one of the optical units in FIG. 11.

FIG. 13 is an effect diagram of a light shape of an optical unit in the related art.

### REFERENCE NUMBERS

vehicle lamp 1000;
lens assembly 100:
reflector 1; light reflection surface 101; fixing portion 102;
lens 2; lens body 201; light incident surface 2011; light-emitting surface 2012; partition 2013; connecting arm 202; second connecting hole 2021; second positioning hole 2022;
light source 3;
light blocking member 4; light blocking portion 401; connecting portion 402; escape portion 4021; first stopping portion 4022; second stopping portion 4023; first thickening portion 4024; second thickening portion 4025; third connecting hole 4026; first positioning hole 4027;
frame body 5; accommodating cavity 501; first stepped surface 5011; second stepped surface 5012; first connecting hole 502; positioning pillar 503; flange 504;
printed circuit board (PCB) 6;
heat sink 7;
first fastener 901; second fastener 902; third fastener 903; and fourth fastener 904.

### DETAILED DESCRIPTION

Hereinafter, embodiments of the present disclosure will be described in detail, examples of which are illustrated in the accompanying drawings. The embodiments described below by referring to the accompanying drawings are exemplary and are intended to explain the present disclosure, and should not be construed as limiting the present disclosure.

Vehicle lamps include a high beam and a low beam. Light of the high beam is emitted in parallel, concentrated and relatively bright, and can irradiate higher and farther objects. Light emitted by the low beam is divergent and can irradiate objects in a relatively large range nearby. As eyes of a vehicle, the vehicle lamps are not only related to the external image of a vehicle owner, but also closely related to safe driving at night or in bad weather conditions. Therefore, the road lighting effect of the vehicle lamps is very important for safe driving. In the related art, stray light exists in a light shape formed by the vehicle lamps on a road surface, which affects the road lighting effect of the vehicle lamps.

Based on at least one of the above technical problems, an embodiment of the present disclosure provides a lens assembly, a vehicle lamp and a vehicle, which can effectively improve or even avoid the stray light, and is beneficial to improving the road lighting effect of the vehicle lamp, thereby improving the driving safety.

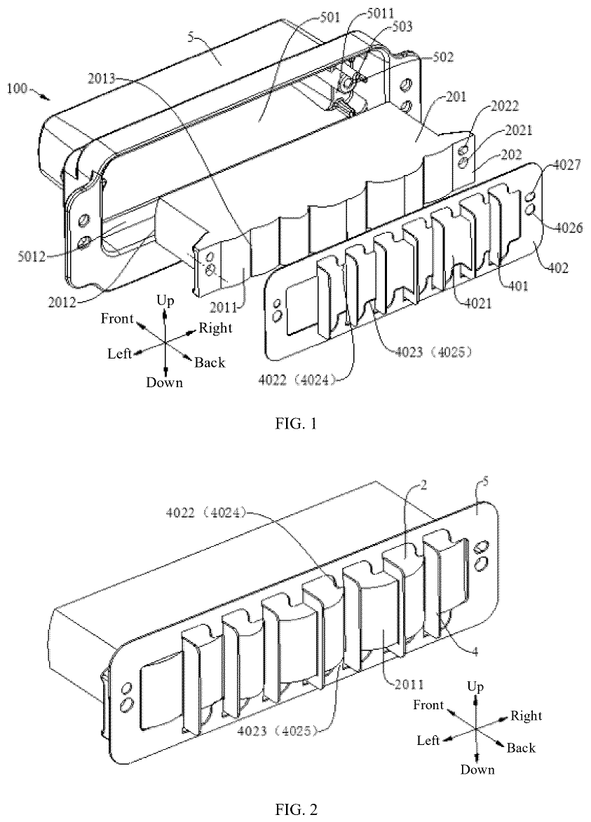

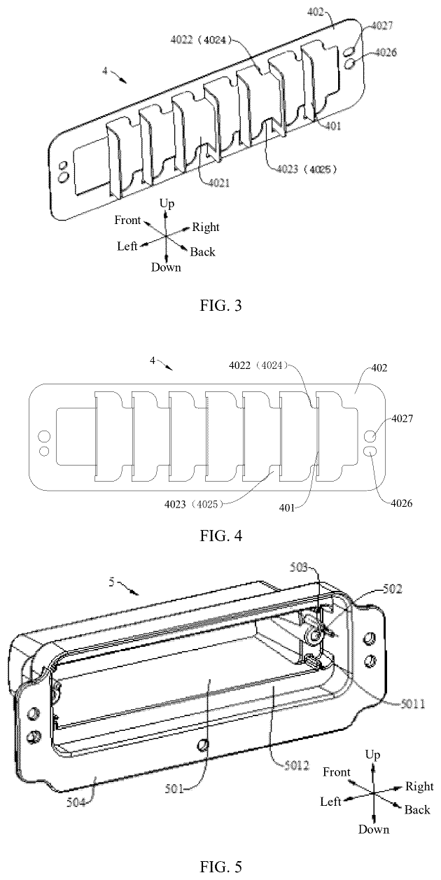

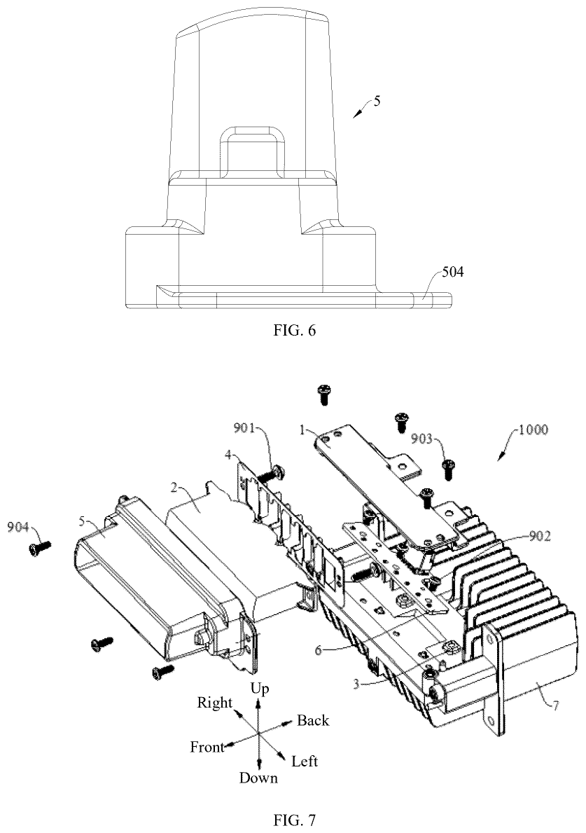

As shown in FIG. 1 to FIG. 11, a lens assembly 100 of the embodiment of the present disclosure includes a lens 2 and a light blocking member 4. The light blocking member 4 includes a plurality of light blocking portions 401, and the lens 2 has a plurality of light incident surfaces 2011. Each of the plurality of light blocking portions 401 is arranged between two adjacent light incident surfaces 2011 to separate the two adjacent light incident surfaces 2011.

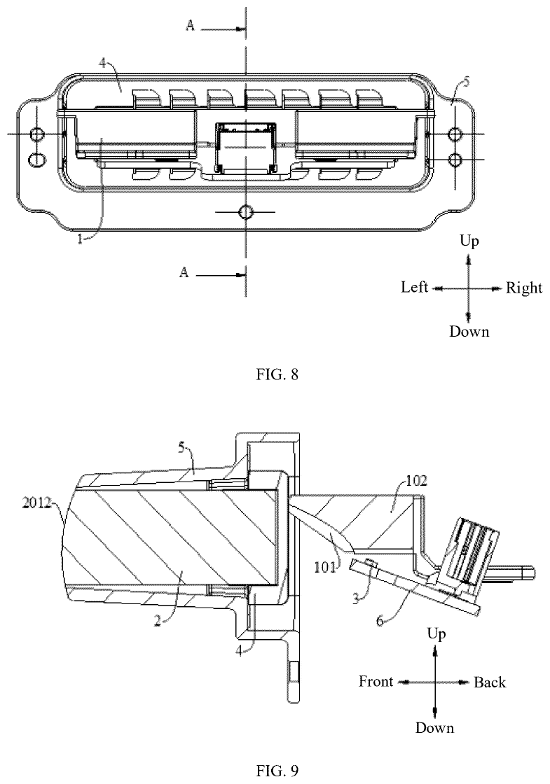

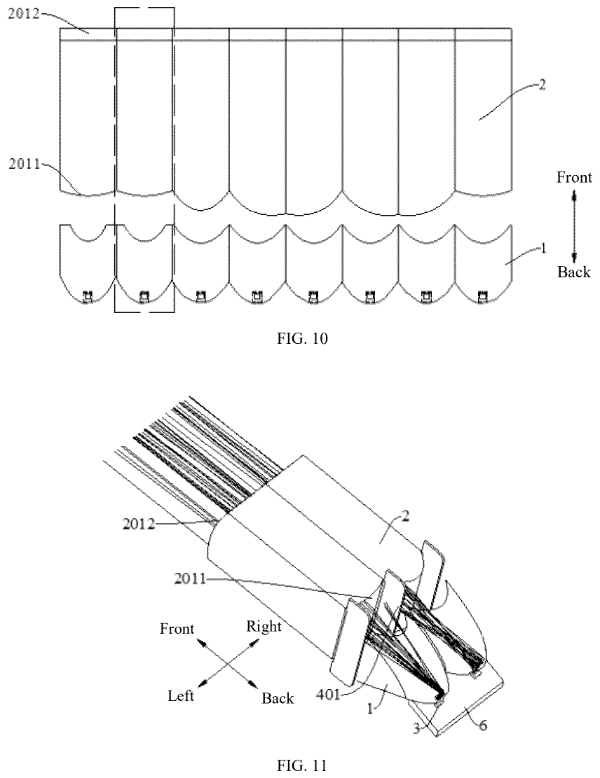

It can be understood that a vehicle lamp 1000 with the lens assembly 100 includes a plurality of light sources 3. Each of the plurality of light incident surfaces 2011 of the lens 2 can be arranged corresponding to a light source 3 or multiple light sources 3. Light emitted by each of the plurality of light sources 3 can directly irradiate a corresponding light incident surface 2011 of the lens 2. The light emitted by the light source 3 can also be reflected by a reflector 1 onto the corresponding light incident surface 2011 of the lens 2. For example, as shown in FIG. 7. FIG. 8. FIG. 9 and FIG. 11, the reflector 1 has a plurality of light reflection surfaces 101. The light incident surface 2011 is arranged corresponding to at least one light source 3 in the plurality of light sources 3, and the light incident surface 2011 is arranged corresponding to at least one light reflection surface 101 in the plurality of light reflection surfaces 101. The light source 3, the light incident surface 2011 and the corresponding light reflection surface 101 form an optical unit (as shown in a dotted box in FIG. 10). The plurality of light sources, the plurality of light incident surfaces 2011 and the plurality of light reflection surfaces 101 form a plurality of optical units. The light emitted by the light source 3 is reflected by the corresponding light reflection surface 101 and then converged near a focus of the corresponding light incident surface 2011, and finally refracted to the road surface by the lens 2 to form illumination.

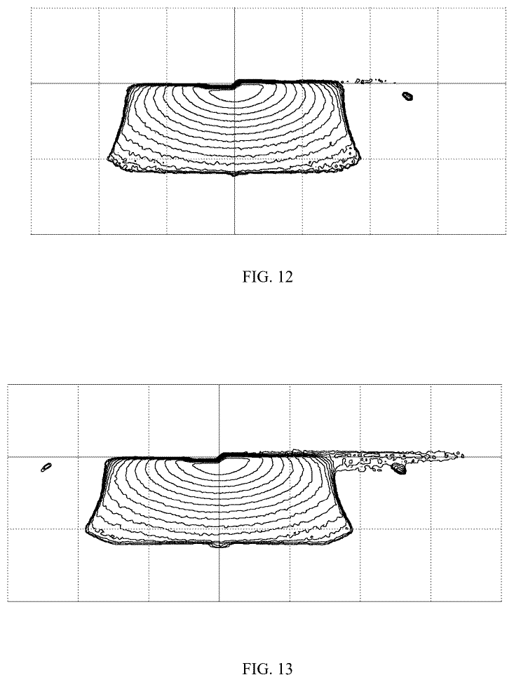

As shown in FIG. 1 and FIG. 11, in the lens assembly 100 of the embodiment of the present disclosure, by arranging the light blocking member 4 and using the light blocking portion 401 of the light blocking member 4 to separate the two adjacent light incident surfaces 2011, the light emitted by the light source 3 can be effectively prevented from irradiating light incident surfaces 2011 of adjacent optical units (as shown in FIG. 11) to form the stray light. When the vehicle lamp 1000 with the lens assembly 100 of the embodiment of the present disclosure works, a light shape formed by the optical units (as shown in FIG. 12) can greatly reduce or even avoid the stray light compared with a light shape formed by optical units in the related art (as shown in FIG. 13), which is beneficial to improving the road lighting effect of the vehicle lamp 1000 with the lens assembly 100.

Therefore, the vehicle lamp 1000 with the lens assembly 100 of the embodiment of the present disclosure has advantages such as good road lighting effect.

In some embodiments, as shown in FIG. 1 to FIG. 4, a plurality of light blocking portions 401 are arranged, and there is a light blocking portion 401 arranged between any two adjacent light incident surfaces 2011.

By arranging the light blocking portion 401 between any two adjacent light incident surfaces 2011, the light emitted by any light source 3 can be effectively prevented from irradiating the light incident surfaces 2011 of adjacent optical units to form the stray light, and thus it is beneficial to further improving the road lighting effect of the vehicle lamp 1000 with the lens assembly 100.

In some embodiments, as shown in FIG. 1 and FIG. 9 to FIG. 11, the lens 2 has a plurality of light-emitting surfaces 2012 corresponding to the plurality of light incident surfaces 2011. Each of the plurality of light incident surfaces 2011 is a light incident surface collimated in a first direction, and each of the plurality of light-emitting surfaces 2012 is a light-emitting surface collimated in a second direction. Each of a plurality of partitions 2013 is formed between two adjacent light incident surfaces 2011, and each of the plurality of light blocking portions 401 is arranged corresponding to one of the plurality of partitions 2013. The first direction is orthogonal to the second direction, that is, the second direction is perpendicular to the first direction.

In order to make technical solutions of the present disclosure easier to understand, the technical solutions of the present disclosure will be further described below by taking the first direction being consistent with a left-right direction and the second direction being consistent with an up-down direction as examples.

The light incident surface 2011 is the light incident surface collimated in the first direction, which can be understood that a section line of the light incident surface 2011 in the first direction (the left-right direction) is a convex curve, and the light incident surface 2011 deflects the light in the left-right direction to a relatively large extent, which can have a certain collimation effect on diverging light; the section line of the light incident surface 2011 in the second direction (the up-down direction) is a straight line, and the light incident surface 2011 has relatively weak ability to deflect the light in the up-down direction and does not have a collimation effect.

The light-emitting surface 2012 is the light-emitting surface collimated in the second direction, which can be understood that a section line of the light-emitting surface 2012 in the second direction (the up-down direction) is a convex curve, and the light-emitting surface 2012 deflects the light in the up-down direction to a relatively large extent, which can have a certain collimation effect on diverging light; the section line of the light-emitting surface 2012 in the first direction (the left-right direction) is a straight line, and the light-emitting surface 2012 has relatively weak ability to deflect the light in the left-right direction and does not have a collimation effect.

On the one hand, by arranging the light incident surface 2011 of the lens 2 as the light incident surface 2011 that is collimated in the first direction, and arranging the light-emitting surface 2012 as the light-emitting surface 2012 that is collimated in the second direction, it is convenient for the lens assembly 100 to form an asymmetric light shape on the road surface, for example, a rectangular light shape with a large size in the left-right direction and a small size in the up-down direction.

On the other hand, by arranging the light blocking portion 401 at the partition 2013, the light emitted by any light source 3 can be effectively prevented from irradiating the light incident surfaces 2011 of adjacent optical units, and at the same time, effective light (light passing through a focus of the reflector 1) emitted by the light source 3 can be prevented from being blocked by the light blocking portion 401, and thus it is beneficial to further improving the road lighting effect of the vehicle lamp 1000 with the lens assembly 100.

In some embodiments, the plurality of light-emitting surfaces 2012 are spaced apart from the plurality of light incident surfaces 2011 along a third direction. The third direction is orthogonal to the second direction and the first direction, that is, the third direction is perpendicular to the second direction and the first direction.

In order to make technical solutions of the present disclosure easier to understand, the technical solutions of the present disclosure will be further described by taking the third direction being consistent with a front-back direction as an example.

As shown in FIG. 1 and FIG. 9, the light-emitting surface 2012 and the light incident surface 2011 are arranged at an interval in the front-back direction, and an upper surface and a lower surface of the lens 2 are both flat. Therefore, the lens 2 has a simple overall structure and is convenient to process and manufacture.

In some embodiments, as shown in FIG. 2 to FIG. 4, the light blocking member 4 further includes a connecting portion 402. The plurality of light blocking portions 401 are connected to the connecting portion 402, and the connecting portion 402 is connected to the lens 2.

By connecting the plurality of light blocking portions 401 to the connecting portion 402, when assembling the lens assembly 100, the light blocking member 4 can be connected to the lens 2 by the connecting portion 402 to form a first subassembly, and then the first subassembly can be connected to other components, and thus it is convenient to fix the light blocking member 4 at a preset position of the lens 2.

Therefore, by arranging the connecting portion 402 on the light blocking member 4, the connecting portion 402 is connected to the lens 2, which not only facilitates the assembly of the lens assembly 100, but also effectively improves the assembly accuracy between the light blocking portion 401 and the light incident surface 2011, and thus it is beneficial to further improving the road lighting effect of the lens assembly 100.

In some embodiments, the connecting portion 402 and the plurality of light blocking portions 401 are of an integrated structure.

In some embodiments, the light blocking member 4 is a stainless steel member, a plastic member or an aluminum alloy member.

In some embodiments, the connecting portion 402 is a connecting plate. The connecting portion 402 has a plurality of escape portions 4021 for the plurality of light incident surfaces 2011 to pass through. The plurality of escape portions 4021 correspond to the plurality of light incident surfaces 2011 in a one-to-one correspondence, the light incident surface 2011 is arranged in the corresponding escape portion 4021, and the light blocking portion 401 is arranged between two adjacent escape portions 4021. The escape portion 4021 can be an escape hole or an escape groove.

For example, as shown in FIG. 2 to FIG. 4, the connecting portion 402 is a connecting plate. The connecting plate is provided with a plurality of escape holes. The plurality of escape holes correspond to the plurality of light incident surfaces 2011 in a one-to-one correspondence. The light incident surface 2011 passes through the escape hole, so that the light incident surface 2011 is located in the corresponding escape portion 4021.

By arranging the plurality of escape portions 4021 on the connecting portion 402 and the light blocking portion 401 between the two adjacent escape portions 4021, it is beneficial to improving the overall structural strength of the light blocking member 4 and the reliability of the lens assembly 100.

In some embodiments, the escape portion 4021 is an escape hole, and a hole wall of the escape hole has a first stopping portion 4022 and a second stopping portion 4023 oppositely arranged in the second direction (the up-down direction). The first stopping portion 4022 and the second stopping portion 4023 respectively stop at both ends of the lens 2 in the second direction (the up-down direction).

By arranging the first stopping portion 4022 and the second stopping portion 4023 on the hole wall of the escape hole, when assembling the lens assembly 100, the first stopping portion 4022 and the second stopping portion 4023 can be used to respectively stop at both ends of the lens 2 in the up-down direction to realize the pre-positioning of the light blocking member 4 and the lens 2, and then the connecting portion 402 is fixedly connected to the lens 2, and thus it is further convenient to fix the light blocking member 4 at the preset position of the lens 2.

In some embodiments, as shown in FIG. 1 to FIG. 3, the hole wall has a first thickening portion 4024 and a second thickening portion 4025. A thickness of the first thickening portion 4024 and the second thickening portion 4025 is greater than a thickness of a remaining portion of the hole wall. The first thickening portion 4024 and the second thickening portion 4025 are arranged at an interval along the second direction (the up-down direction). The first thickening portion 4024 forms the first stopping portion 4022, and the second thickening portion 4025 forms the second stopping portion 4023.

The first stopping portion 4022 is formed by the first thickening portion 4024 of the hole wall, and the second stopping portion 4023 is formed by the second thickening portion 4025 of the hole wall, which makes the overall structure of the connecting portion 402 simple and convenient for design and processing.

In some embodiments, the escape portion 4021 is an escape groove, and a groove wall of the escape groove has a first stopping portion 4022 and a second stopping portion 4023 oppositely arranged in the second direction (the up-down direction). The first stopping portion 4022 and the second stopping portion 4023 respectively stop at both ends of the lens 2 in the second direction.

By arranging the first stopping portion 4022 and the second stopping portion 4023 on the groove wall of the escape groove, when assembling the lens assembly 100, the first stopping portion 4022 and the second stopping portion 4023 can be used to respectively stop at both ends of the lens 2 in the second direction (the up-down direction) to realize the pre-positioning of the light blocking member 4 and the lens 2, and thus it is further convenient to fix the light blocking member 4 at the preset position of the lens 2.

In some embodiments, the groove wall has a first thickening portion 4024 and a second thickening portion 4025. A thickness of the first thickening portion 4024 and the second thickening portion 4025 is greater than a thickness of a remaining portion of the groove wall. The first thickening portion 4024 and the second thickening portion 4025 are arranged at an interval along the second direction. The first thickening portion 4024 forms the first stopping portion 4022, and the second thickening portion 4025 forms the second stopping portion 4023.

The first stopping portion 4022 is formed by the first thickening portion 4024 of the groove wall, and the second stopping portion 4023 is formed by the second thickening portion 4025 of the groove wall, which makes the overall structure of the connecting portion 402 simple and convenient for design and processing.

Certainly, in other embodiments, the first stopping portion 4022 can also be a protrusion, and the second stopping portion 4023 can also a protrusion.

In some embodiments, the light blocking portion 401 is a light blocking plate or a light blocking strip.

For example, as shown in FIG. 1 to FIG. 4, the light blocking portion 401 is a rectangular plate. Long edges of the rectangular plate extend in the up-down direction, and short edges of the rectangular plate extend in the front-back direction. For another example, the light blocking portion 401 is the light blocking strip extending in the up-down direction.

By arranging the light blocking portion 401 as the light blocking plate or the light blocking strip, it is not only convenient for the processing and manufacturing of the light blocking portion 401, but also has a good light blocking effect.

When the connecting portion 402 is a connecting plate and the light blocking portion 401 is the light blocking plate, the plurality of light blocking portions 401 are arranged on a side of the connecting portion 402 away from the plurality of light-emitting surfaces 2012, so that the connecting portion 402 and the plurality of light blocking portions 401 are arranged in a T-shape.

As shown in FIG. 1 to FIG. 4, the connecting portion 402 is a connecting plate extending in the left-right direction, the light blocking portion 401 is a light blocking plate extending in the up-down direction, and a plurality of light blocking plates are arranged at a rear side of the connecting plate.

By arranging the connecting portion 402 as the connecting plate and the light blocking portion 401 as the light blocking plate, the connecting portion 402 and the plurality of light blocking portions 401 are arranged in the T-shape, so that the component formed by the connecting portion 402 and the plurality of light blocking portions 401 is simple in structure and convenient to process.

In some embodiments, a spacing between the partition 2013 and the light incident surface 2011 in the third direction (the front-back direction) is from 0.1 mm to 1 mm. In other words, the spacing between the partition 2013 and the light incident surface 2011 in the third direction (the front-back direction) is greater than or equal to 0.1 mm and less than or equal to 1 mm.

For example, the light blocking portion 401 is the light blocking plate, and the spacing between the light blocking plate and the light incident surface 2011 in the third direction is equal to 0.4 mm.

By arranging the spacing between the partition 2013 and the light incident surface 2011 to be greater than or equal to 0.1 mm in the third direction, it is possible to effectively prevent the light blocking portion 401 from contacting with light incident surfaces 2011 located at both sides of the light blocking portion 401 and damaging the light incident surfaces 2011 of the lens 2. By arranging the spacing between the partition 2013 and the light incident surface 2011 to be less than or equal to 1 mm in the front-back direction, a gap between the light blocking portion 401 and the light incident surface 2011 is not too large, so that the light emitted by the light source 3 can be more effectively prevented from irradiating the light incident surfaces 2011 of the adjacent optical units to form the stray light, and thus it is beneficial to further improving the road lighting effect of the vehicle lamp 1000 with the lens assembly 100.

In some embodiments, a size of the light blocking portion 401 in the second direction (the up-down direction) is greater than or equal to a size of the light incident surface 2011. In other words, in the up-down direction, the size of the light blocking portion 401 is greater than or equal to the size of the light incident surface 2011.

For example, the light blocking portion 401 is the light blocking plate, and the size of the light blocking plate in the up-down direction is larger than the size of the light incident surface 2011, that is, a length of the light blocking plate is larger than a length of the light incident surface 2011.

By setting the size of the light blocking portion 401 in the second direction to be greater than or equal to the size of the light incident surface 2011, two adjacent light incident surfaces 2011 can be separated from each other in the up-down direction by the light blocking portion 401, thereby effectively preventing the light emitted by the light source 3 from irradiating the light incident surfaces 2011 of adjacent optical units to form the stray light, and thus it is beneficial to further improving the road lighting effect of the vehicle lamp 1000 with the lens assembly 100.

In some embodiments, the size of the light blocking portion 401 in the third direction (the front-back direction) is from 1 mm to 10 mm. In other words, the size of the light blocking portion 401 in the third direction is greater than or equal to 1 mm and less than or equal to 10 mm.

For example, the light blocking portion 401 is the light blocking plate, and the size of the light blocking plate in the front-back direction is 5 mm, that is, a width of the light blocking plate is 5 mm.

By setting the size of the light blocking portion 401 to be from 1 mm to 10 mm in the third direction, not only the defocus light emitted by the reflector 1 can be effectively blocked by the light blocking portion 401, but also the size of the light blocking portion 401 in the third direction is not too large, and thus it is beneficial to saving the material cost and reducing the weight of the light blocking portion 401, thereby reducing the cost and weight of the lens assembly 100.

In some embodiments, a size of the light blocking portion 401 in the first direction (the left-right direction) is from 0.1 mm to 2 mm. In other words, the size of the light blocking portion 401 in the first direction is greater than or equal to 0.1 mm and less than or equal to 2 mm.

For example, the light blocking portion 401 is the light blocking plate, and the size of the light blocking plate in the left-right direction is 0.4 mm, that is, a thickness of the light blocking plate is 0.4 mm.

By setting the size of the light blocking portion 401 to be from 0.1 mm to 2 mm in the first direction, on the one hand, the light blocking portion 401 can meet certain strength requirements; on the other hand, the size of the light blocking portion 401 in the first direction is not too large, which is not only beneficial to saving the material cost and reducing the weight of the light blocking portion 401, thereby reducing the cost and weight of the lens assembly 100, but also can effectively prevent the effective light emitted by the light source 3 from being blocked by the light blocking portion 401, and thus it is beneficial to further improving the road lighting effect of the vehicle lamp 1000 with the lens assembly 100.

In some embodiments, the lens assembly 100 further includes a frame body 5, and both the connecting portion 402 and the lens 2 are connected to the frame body 5.

As shown in FIG. 1 and FIG. 7 to FIG. 9, the lens assembly 100 includes a frame body 5. The frame body 5 is used to support the lens 2. When assembling the vehicle lamp 1000, the connecting portion 402 and the lens 2 can be connected to the frame body 5 to form a first subassembly, and then the first subassembly can be connected to other components, thereby facilitating the assembly of the lens assembly 100.

In some embodiments, the frame body 5 is a cover body with an accommodating cavity 501. The lens 2 is arranged in the accommodating cavity 501, and at least a part of the light blocking member 4 is arranged in the accommodating cavity 501.

At least a part of the light blocking member 4 is arranged in the accommodating cavity 501, which can be understood that the whole light blocking member 4 is located in the accommodating cavity 501; or a part of the light blocking member 4 is located in the accommodating cavity 501, and the other part of the light blocking member 4 is located outside the accommodating cavity 501.

For example, as shown in FIG. 1 and FIG. 7 to FIG. 9, both the lens 2 and the light blocking member 4 are integrally arranged in the accommodating cavity 501.

By arranging the lens 2 in the accommodating cavity 501, the frame body 5 can be used to protect the lens 2, thereby effectively preventing other components from damaging the lens 2 during the assembly of the vehicle lamp 1000. By arranging the lens 2 in the accommodating cavity 501 and at least a part of the light blocking member 4 in the accommodating cavity 501, the volume of the first subassembly composed of the light blocking member 4, the lens 2 and the frame body 5 can be effectively reduced, and thus it is beneficial to further reducing the overall volume and occupied space of the vehicle lamp 1000.

In some embodiments, as shown in FIG. 1, the lens 2 includes a lens body 201 and a connecting arm 202 which are connected. The plurality of light incident surfaces 2011 and the plurality of light-emitting surfaces 2012 are arranged on the lens body 201, and the connecting portion 402, the connecting arm 202 and the frame body 5 are detachably connected through fasteners.

For example, as shown in FIG. 1 to FIG. 5, the frame body 5 has a first connecting hole 502, the connecting arm 202 has a second connecting hole 2021, the connecting portion 402 has a third connecting hole 4026, and the vehicle lamp 1000 further includes a first fastener 901. The first fastener 901 passes through the third connecting hole 4026 and the second connecting hole 2021 and is connected to the first connecting hole 502.

By using the fasteners to connect the light blocking member 4 and the lens 2 to the frame body 5, it is convenient to disassemble the light blocking member 4 and the lens 2, thereby facilitating the maintenance and replacement of the light blocking member 4 and the lens 2.

In some embodiments, the first fastener 901 can be a bolt, a screw, or the like.

In some embodiments, one of the frame body 5 and the connecting portion 402 has a positioning pillar 503, the other of the frame body 5 and the connecting portion 402 has a first positioning hole 4027, and the connecting arm 202 has a second positioning hole 2022. A part of the positioning pillar 503 is inserted into the first positioning hole 4027, the part of the positioning pillar 503 is matched with the first positioning hole 4027, another part of the positioning pillar 503 is inserted into the second positioning hole 2022, and the another part of the positioning pillar 503 is matched with the second positioning hole 2022.

For example, as shown in FIG. 1 to FIG. 5, the frame body 5 has a positioning pillar 503, and the connecting portion 402 has a first positioning hole 4027. The positioning pillar 503, the first positioning hole 4027 and the second positioning hole 2022 all extend in the front-back direction. A part of the positioning pillar 503 is inserted into the first positioning hole 4027, and the part of the positioning pillar 503 is matched with the first positioning hole 4027. Another part of the positioning pillar 503 is inserted into the second positioning hole 2022, and the another part of the positioning pillar 503 is matched with the second positioning hole 2022. Therefore, by using the first positioning hole 4027, the second positioning hole 2022 and the positioning pillar 503, the positioning of the connecting portion 402 and the lens 2 in the left-right direction and the up-down direction can be realized.

When assembling the lens assembly 100, the positioning pillar 503 can be inserted into the first positioning hole 4027 and the second positioning hole 2022 to realize the pre-positioning of the light blocking member 4 and the lens 2 on the frame body 5, and then the light blocking member 4 and the lens 2 can be fixedly connected to the frame body 5, thereby facilitating the assembly of the lens assembly 100.

In some embodiments, the cavity wall of the accommodating cavity 501 has a first stepped surface 5011 and a second stepped surface 5012 perpendicular to the third direction. The second stepped surface 5012 is located between the first stepped surface 5011 and the connecting portion 402 in the third direction, the connecting arm 202 stops at the first stepped surface 5011 in the third direction, and a part of the connecting portion 402 stops at the second stepped surface in the third direction.

For example, as shown in FIG. 1 and FIG. 5, the first stepped surface 5011 is arranged at a front side of the second stepped surface 5012, and the second stepped surface 5012 is arranged at a front side of the connecting portion 402. The connecting arm 202 of the lens 2 stops at the first stepped surface 5011 in the third direction, and the first connecting hole 502 and the positioning pillar 503 are arranged on the first stepped surface 5011. An edge portion of the connecting portion 402 stops at the second stepped surface 5012 in the third direction.

By stopping the connecting arm 202 at the first stepped surface 5011 and the connecting portion 402 at the second stepped surface 5012, it can effectively prevent the connecting portion 402 from being pressed against the lens 2 to cause the lens 2 to be damaged during the assembly of the first subassembly.

In some embodiments, the first stepped surface 5011 and the second stepped surface 5012 are provided on different cavity walls of the accommodating cavity 501.

For example, the first stepped surface 5011 is provided on a left-right wall of the accommodating cavity 501, and the second stepped surface 5012 is provided on an up-down wall of the accommodating cavity 501.

As shown in FIG. 7 to FIG. 11, a vehicle lamp 1000 according to an embodiment of the present disclosure includes the lens assembly 100 described in any of the above embodiments.

The vehicle lamp 1000 can be a high beam or a low beam.

Therefore, the vehicle lamp 1000 of the embodiment of the present disclosure has advantages such as good road lighting effect.

In some embodiments, the vehicle lamp 1000 further includes a plurality of light sources 3 and a reflector 1. The reflector 1 has a plurality of light reflection surfaces 101, each of the plurality of light incident surfaces 2011 is arranged corresponding to one or more light reflection surfaces 101 in the plurality of light reflection surfaces 101, and each of the plurality of light reflection surfaces 101 is arranged corresponding to one or more light sources 3 in the plurality of light sources 3.

For example, as shown in FIG. 10, the light source 3, the light reflection surface 101 and the light incident surface 2011 are in a one-to-one correspondence and form an optical unit.

In some embodiments, the light source 3 is a surface light source, and the number of the light sources 3 is from 5 to 10.

For example, as shown in FIG. 10, the number of the light sources 3 is 8. In one embodiment, the light source is a light emitting diode (LED).

In some embodiments, the light reflection surface 101 is a parabolic light reflection surface.

In some embodiments, a size of the light reflection surface 101 in the first direction is from 5 mm to 15 mm.

For example, a size of the light reflection surface 101 in the left-right direction is 10 mm.

In some embodiments, a focal length of the light reflection surface 101 is from 0.5 mm to 3 mm.

For example, the focal length of the light reflection surface 101 is 1 mm, which makes the focal length of the light reflection surface 101 relatively small, and thus it is beneficial to improving the brightness and light efficiency of the lens assembly 100 irradiated on the road surface.

In some embodiments, as shown in FIG. 7 and FIG. 9, the reflector 1 includes a reflecting portion and a fixing portion 102. The reflecting portion and the fixing portion 102 are of an integrated structure, and the light reflection surface 101 is arranged on the reflecting portion.

In some embodiments, as shown in FIG. 7, the vehicle lamp 1000 further includes a printed circuit board (PCB) 6 and a heat sink 7. The light source 3 is disposed on the PCB 6, and the PCB 6 is connected to the heat sink 7 through a second fastener 902. The fixing portion 102 is connected to the heat sink 7 through a third fastener 903.

In some embodiments, a frame body 5 has a flange 504, and the heat sink 7 is connected to the flange 504 through a fourth fastener 904.

The second fastener 902, the third fastener 903 and the fourth fastener 904 can be bolts, screws, and the like.

When assembling the vehicle lamp 1000, firstly, the lens 2, the light blocking member 4 and the frame body 5 are assembled into a first subassembly, and the reflector 1, the light source 3, the PCB 6 and the heat sink 7 are assembled into a second subassembly; then, the second subassembly is connected to the first subassembly through the fourth fastener 904.

The vehicle of the embodiment of the present disclosure includes the vehicle lamp 1000 described in any of the above embodiments.

Therefore, the vehicle of the embodiment of the present disclosure has advantages such as good safety.

In the description of the present disclosure, it should be understood that orientation or position relationships indicated by terms such as “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial direction”, “radial direction”, “circumferential direction”, or the like are based on orientation or position relationships shown in the accompanying drawings, and are merely used for describing the present disclosure and simplifying the description, rather than indicating or implying that the mentioned apparatus or an element needs to have a particular orientation or be constructed and operated in a particular orientation, and therefore, should not be construed as a limitation on the present disclosure.

In addition, terms “first” and “second” are only used to describe the objective and cannot be understood as indicating or implying relative importance or implying a quantity of the indicated technical features. In view of this, a feature defined to be “first” or “second” may explicitly or implicitly include one or more features. In the description of the present disclosure. “a plurality of” means two or more, unless otherwise clearly and specifically defined.

In the present disclosure, unless otherwise explicitly specified and limited, terms such as “mount”, “connected”, “connect”, and “fix” should be understood in a broad sense. For example, a connection may be a fixed connection, a detachable connection, or an integral connection, may be a mechanical connection or an electrical connection, or may be a direct connection, an indirect connection through an intermediate medium, internal communication between two elements, or an interaction relationship between two elements, unless otherwise explicitly limited. A person of ordinary skill in the art may understand the meanings of the foregoing terms in the present disclosure according to situations.

In the present disclosure, unless otherwise explicitly specified and limited, a first feature being “on” or “under” a second feature may be the first feature directly contacting the second feature, or the first feature indirectly contacting the second feature through an intermediate medium. In addition, the first feature being “above”, “over”, or “on” the second feature may mean that the first feature is above or obliquely above the second feature, or may merely mean that a horizontal position of the first feature is higher than a horizontal position of the second feature. The first feature being “below”, “under”, and “beneath” the second feature may mean that the first feature is under or obliquely below the second feature, or may merely mean that the horizontal position of the first feature is lower than the horizontal position of the second feature.

In the description of the present disclosure, descriptions with reference to terms such as “an embodiment”, “some embodiments”, “example”, “specific example”, or “some examples” mean that features, structures, materials, or characteristics described with reference to the embodiment or example are included in one or more embodiments or examples of the present disclosure. In this specification, illustrative expressions of these terms do not necessarily refer to the same embodiment or example. Moreover, the features, structures, materials, or characteristics described may be combined in any suitable manner in any one or more embodiments or examples. In addition, without mutual contradiction, a person skilled in the art may incorporate and combine different embodiments or examples and features of the different embodiments or examples described in this specification.

Although the embodiments of the present disclosure are shown and described above, it can be understood that the foregoing embodiments are exemplary, and cannot be construed as a limitation on the present disclosure. A person of ordinary skill in the art may make changes, modifications, replacements, and variations based on the foregoing embodiments within the scope of the present disclosure.

1. A lens assembly, comprising:
a lens comprising a plurality of light incident surfaces; and
a light blocking member comprising a plurality of light blocking portions, wherein each of the plurality of light blocking portions is arranged between two adjacent light incident surfaces in the plurality of light incident surfaces to separate the two adjacent light incident surfaces;
wherein the lens comprises a plurality of light-emitting surfaces corresponding to the plurality of light incident surfaces, each of the plurality of light incident surfaces is a light incident surface collimated in a first direction, each of the plurality of light-emitting surfaces is a light-emitting surface collimated in a second direction, each of a plurality of partitions is formed between two adjacent light incident surfaces, and each of the plurality of light blocking portions is arranged corresponding to one of the plurality of partitions, wherein the first direction is orthogonal to the second direction.

2. (canceled)

3. The lens assembly according to claim 1, wherein the light blocking portion is a light blocking plate or a light blocking strip; and/or
a spacing between each of the plurality of partitions and adjacent light incident surface is from 0.1 mm to 1 mm; and/or
a size of each of the plurality of light blocking portions in the first direction is from 0.1 mm to 2 mm.

4. The lens assembly according to claim 1, wherein the plurality of light incident surfaces are spaced apart from the plurality of light-emitting surfaces along a third direction, wherein the third direction is orthogonal to the second direction and the first direction.

5. The lens assembly according to claim 3, wherein a size of each of the plurality of light blocking portions in the second direction is greater than or equal to a size of each of the plurality of light incident surfaces; and/or
a size of each of the plurality of light blocking portions in the third direction is from 1 mm to 10 mm; and/or
the light blocking member further comprises a connecting portion, the plurality of light blocking portions are connected to the connecting portion, and the connecting portion is connected to the lens.

6. The lens assembly according to claim 5, wherein the light blocking member comprises a connecting portion, the connecting portion is a connecting plate, and the connecting portion comprises a plurality of escape portions for the plurality of light incident surfaces to pass through, the plurality of escape portions correspond to the plurality of light incident surfaces in a one-to-one correspondence, each of the plurality of light incident surfaces is arranged in a corresponding escape portion, and each of the plurality of light blocking portions is arranged between two adjacent escape portions in the plurality of escape portions.

7. The lens assembly according to claim 6, wherein the escape portion is an escape hole, wherein a hole wall of the escape hole comprises a first stopping portion and a second stopping portion oppositely arranged in the second direction, and the first stopping portion and the second stopping portion respectively stop at both ends of the lens in the second direction; or
the escape portion is an escape groove, a groove wall of the escape groove comprises a first stopping portion and a second stopping portion oppositely arranged in the second direction, and the first stopping portion and the second stopping portion respectively stop at both ends of the lens in the second direction.

8. The lens assembly according to claim 6- or 7, wherein when the escape portion is the escape hole, the hole wall comprises a first thickening portion and a second thickening portion, a thickness of the first thickening portion and the second thickening portion is greater than a thickness of a remaining portion of the hole wall, the first thickening portion forms the first stopping portion, and the second thickening portion forms the second stopping portion; or
when the escape portion is the escape groove, the groove wall comprises a first thickening portion and a second thickening portion, a thickness of the first thickening portion and the second thickening portion is greater than a thickness of a remaining portion of the groove wall, the first thickening portion forms the first stopping portion, and the second thickening portion forms the second stopping portion.

9. The lens assembly according to claim 5, wherein the light blocking portion is a light blocking plate, and the light blocking portion is arranged on a side of the connecting portion away from the light-emitting surface.

10. The lens assembly according to claim 5, wherein the light blocking member comprises the connecting portion, and the lens assembly further comprises a frame body, and both the connecting portion and the lens are connected to the frame body.

11. The lens assembly according to claim 10, wherein the frame body is a cover body with an accommodating cavity, the lens is arranged in the accommodating cavity, and at least a part of the light blocking member is arranged in the accommodating cavity.

12. The lens assembly according to claim 10, wherein the lens comprises a lens body and a connecting arm which are connected, the plurality of light incident surfaces and the plurality of light-emitting surfaces are arranged on the lens body, and the connecting portion, the connecting arm and the frame body are detachably connected through fasteners; and/or
one of the frame body and the connecting portion comprises a positioning pillar, the other of the frame body and the connecting portion comprises a first positioning hole, and the connecting arm comprises a second positioning hole, wherein a part of the positioning pillar is inserted into the first positioning hole, the part of the positioning pillar is matched with the first positioning hole, another part of the positioning pillar is inserted into the second positioning hole, and the another part of the positioning pillar is matched with the second positioning hole.

13. The lens assembly according to claim 12, wherein a cavity wall of the accommodating cavity comprises a first stepped surface and a second stepped surface perpendicular to the third direction, the second stepped surface is located between the first stepped surface and the connecting portion in the third direction, the connecting arm stops at the first stepped surface in the third direction, and a part of the connecting portion stops at the second stepped surface in the third direction.

14. A vehicle lamp, comprising the lens assembly according to claim 1.

15. The vehicle lamp according to claim 14, wherein the vehicle lamp further comprises a reflector, the reflector comprises a plurality of light reflection surfaces, each of the plurality of light incident surfaces is arranged corresponding to one or more light reflection surfaces in the plurality of light reflection surfaces, and a focal length of the light reflection surfaces is from 0.5 mm to 3 mm.

16. A vehicle, comprising the vehicle lamp according to claim 14.

17. The lens assembly according to claim 5, wherein the connecting portion and the plurality 10 of light blocking portions are of an integrated structure.

18. The lens assembly according to claim 12, wherein the frame body has a first connecting hole, the connecting arm has a second connecting hole, the connecting portion has a third connecting hole, and a first fastener passes through the third connecting hole and the second 15 connecting hole and is connected to the first connecting hole.

19. The lens assembly according to claim 13, wherein the first stepped surface and the second stepped surface are provided on different cavity walls of the accommodating cavity.

20. The vehicle lamp according to claim 15, wherein the vehicle lamp further comprises a plurality of light sources, and each of the plurality of light reflection surfaces is arranged corresponding to one or more light sources in the plurality of light sources.

21. The vehicle lamp according to claim 15, wherein the reflector comprises a reflecting portion and a fixing portion, the reflecting portion and the fixing portion are of an integrated structure, and the light reflection surface is arranged on the reflecting portion.
